(19) United States
(12) Patent Application Publication
(10) Pub. No.: US 2020/0374198 A1
(43) Pub. Date: Nov. 26, 2020

(54) CONTROL METHOD, CONTROL DEVICE, CONTROL SYSTEM AND RECORDING MEDIUM

(71) Applicant: NEC CORPORATION, Tokyo (JP)

(72) Inventors: Takehiro SUZUKI, Tokyo (JP); Osamu MATSUDA, Tokyo (JP)

(73) Assignee: NEC CORPORATION, Tokyo (JP)

(21) Appl. No.: 16/766,580

(22) PCT Filed: Dec. 7, 2018
(86) PCT No.: PCT/JP2018/045017

§ 371 Date: May 22, 2020

(30) Foreign Application Priority Data
Dec. 11, 2017 (JP) 2017-236555

(51) Int. Cl. H04L 12/24; H04L 29/06

(52) U.S. Cl. CPC H04L 41/0893; H04L 41/0816; H04L 41/22; H04L 69/08; H04L 41/12

(57) ABSTRACT

In order to reduce a load applied to a device control of a network manager, in a control method according to the present invention, a control device for controlling network devices receives first instruction information on the network devices, generates, from the first instruction information, second instruction information corresponding to each of the network devices, and transmits the corresponding second instruction information to each of the network devices, when the first instruction information satisfies a prescribed condition.

### TECHNICAL FIELD

The present invention relates to a control method, a control device, a control system, and a recording medium for controlling network apparatuses, and especially relates to a control device, a control system, a control method, and a recording medium that perform conversion of instruction information to be transmitted to the network apparatuses.

### BACKGROUND ART

When managing a network, there is a method of using a command line interface (CLI) as one of methods for making a setting for a network apparatus such as a router or a switch constituting the network.

When making settings of a plurality of network apparatuses with a CLI, it is necessary that a command is input to each network apparatus being a management target, and transmitted. Therefore, when making settings of a plurality of network apparatuses with a CLI, a network administrator needs to input an individual command to each of the plurality of network apparatuses, and transmit the command to each network apparatus. Consequently, as scale and complexity of a network increase, a lot of time and work are required for making a setting of a network apparatus. Thus, when making a common setting of a plurality of network apparatuses, it is required that a command can be transmitted in a batch.

For example, PTL 1 discloses an invention capable of transmitting setting information in a batch to a plurality of network apparatuses by selecting, on a graphical user interface (GUI), a network apparatus to be a control target, and inputting a command to a CLI console.

### CITATION LIST

### Patent Literature

[PTL 1] Japanese Patent No. 4869831

### SUMMARY OF INVENTION

### Technical Problem

An analysis described below is made by inventors of the present invention. There is a performance difference among each of network apparatuses constituting a network due to a difference in vendor, OS, OS version, and the like. Therefore, in order to execute processing on each of the network apparatuses, it is necessary to set an environmental variable of a command to a value relevant to performance of each of the network apparatuses.

The environmental variable is a variable for storing a value to be set for each network apparatus. For example, the environmental variable is a hostname of each network apparatus, and an interface such as a port number of each network apparatus.

However, the invention of the PTL 1 described above is not in consideration of an environmental variable included in a command. Therefore, with respect to separate network apparatuses A and B, for example, in a case where a setting that activates an interface 1 of a network apparatus A is made for the network apparatus A, and a setting that activates an interface 2 is made for a network apparatus B, although an instruction content “activate interface” is common, it is required in the invention of PTL 1 described above that environmental variables having different values are set for each of the network apparatuses A and B, as a number of the interface to be activated. In other words, a command for the network apparatus A and a command for the network apparatus B are required to be individually input, and thus there is a problem that an amount of time and work taken by a network administrator is large.

The present invention is made in view of the above-described problem, and an object of the present invention is to provide a control method, a control device, a control system, and a recording medium that reduce a burden on apparatus control by a network administrator.

### Solution to Problem

According to a first aspect of the present invention, a control method is provided in which a control device controlling network apparatuses receives first instruction information for the network apparatuses, generates, when the first instruction information satisfies a predetermined condition, second instruction information relevant to each of the network apparatuses from the first instruction information, and transmits the relevant second instruction information to each of the network apparatuses.

According to a second aspect of the present invention, a control device is provided that includes a reception means for receiving first instruction information for network apparatuses, a generation means for generating, when the first instruction information satisfies a predetermined condition, second instruction information relevant to each of the network apparatuses from the first instruction information, and a transmission means for transmitting the generated second instruction information to each of the relevant network apparatuses.

According to a third aspect of the present invention, a control system is provided that includes a control device including a reception means for receiving first instruction information for network apparatuses, a generation means for generating, when the first instruction information satisfies a predetermined condition, second instruction information relevant to each of the network apparatuses from the first instruction information, and a transmission means for transmitting the generated second instruction information to each of the relevant network apparatuses, and the network apparatuses controlled by the control device.

According to a fourth aspect of the present invention, a recording medium is provided that records a program causing a control device that controls network apparatuses to execute processing of receiving first instruction information for the network apparatuses, processing of generating, when the first instruction information satisfies a predetermined condition, second instruction information relevant to each of the network apparatuses from the first instruction information, and processing of transmitting the relevant second instruction information to each of the network apparatuses.

### Advantageous Effects of Invention

According to the present invention, a burden on a network administrator can be reduced.

### BRIEF DESCRIPTION OF DRAWINGS

FIG. 1 is a diagram illustrating a configuration of a control system according to the present invention.

FIG. 2 is a diagram illustrating a configuration of a control device according to an example embodiment 1.

FIG. 3 is a diagram illustrating one example of environmental variable conversion information held by a storing unit.

FIG. 4 is a flowchart for describing an operation of command conversion processing of a generation unit of a control system according to the first example embodiment.

FIG. 5 is a diagram illustrating a configuration of a control device according to a second example embodiment.

FIG. 6 is a diagram illustrating one example of apparatus information acquired by a preparation unit.

FIG. 7 is a diagram illustrating one example of command language conversion information held by the storing unit.

FIG. 8 is a flowchart for describing an operation of command conversion processing performed by a command language conversion unit, among operations of a control system according to the second example embodiment.

FIG. 9 is a diagram illustrating a configuration of a GUI unit.

FIG. 10 is a diagram illustrating an operation example of the GUI unit.

FIG. 11 is a block diagram illustrating an overview of the control device.

FIG. 12 is a block diagram illustrating an overview of the control system.

FIG. 13 is a block diagram illustrating one example of a hardware configuration of the control device.

### EXAMPLE EMBODIMENT

### First Example Embodiment

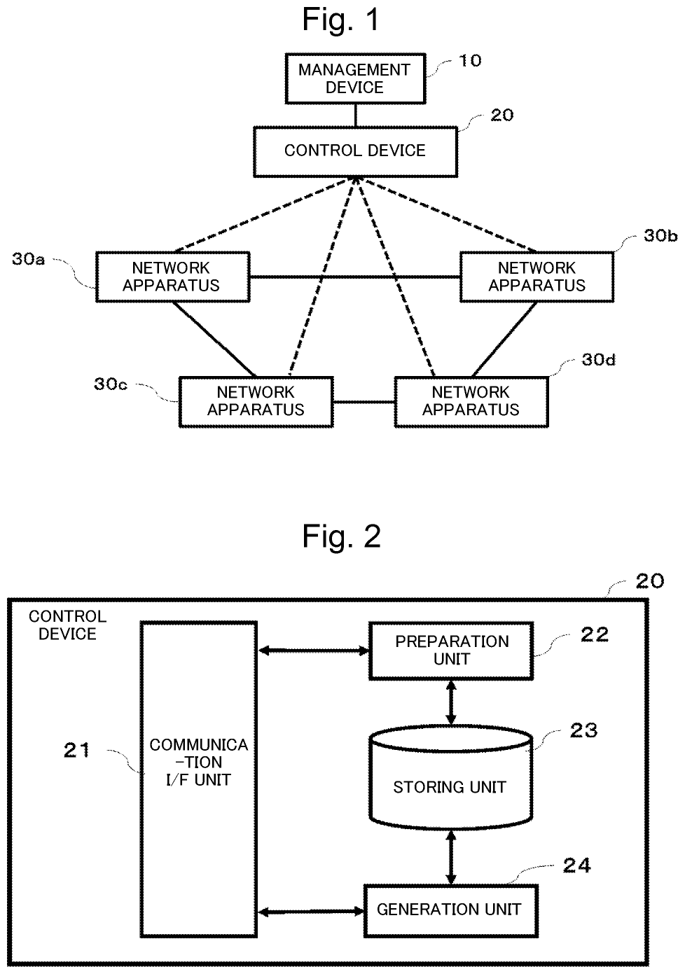

A first example embodiment of the present invention is described in detail by using FIG. 1.

A direction of an arrow in a drawing represents one example, and does not limit a direction of a signal between blocks.

### [Description of Configuration]

FIG. 1 is a diagram illustrating a configuration of a control system according to the present invention. The control system in FIG. 1 includes a management device 10, a control device 20, and network apparatuses 30a to 30d.

The control device 20 connects to the management device 10 and the network apparatuses 30a to 30d each other.

A network administrator inputs, by operating the management device 10, a setting instruction for the network apparatuses 30a to 30d, and transmits the input setting instruction to the control device 20. Hereinafter, the setting instruction input by the network administrator described above is referred to as input instruction information.

Input instruction information is, for example, a command for causing a network apparatus to execute “restart”, “activation of an interface”, and the like.

FIG. 2 is a diagram illustrating a configuration of the control device 20.

The control device 20 includes a communication interface (I/F) unit 21, a preparation unit 22, a storing unit 23, and a generation unit 24.

The preparation unit 22 acquires, via the communication interface unit 21, topology information from the network apparatuses 30a to 30d, and prepares environmental variable conversion information, based on the acquired topology information.

The storing unit 23 holds the prepared environmental variable conversion information.

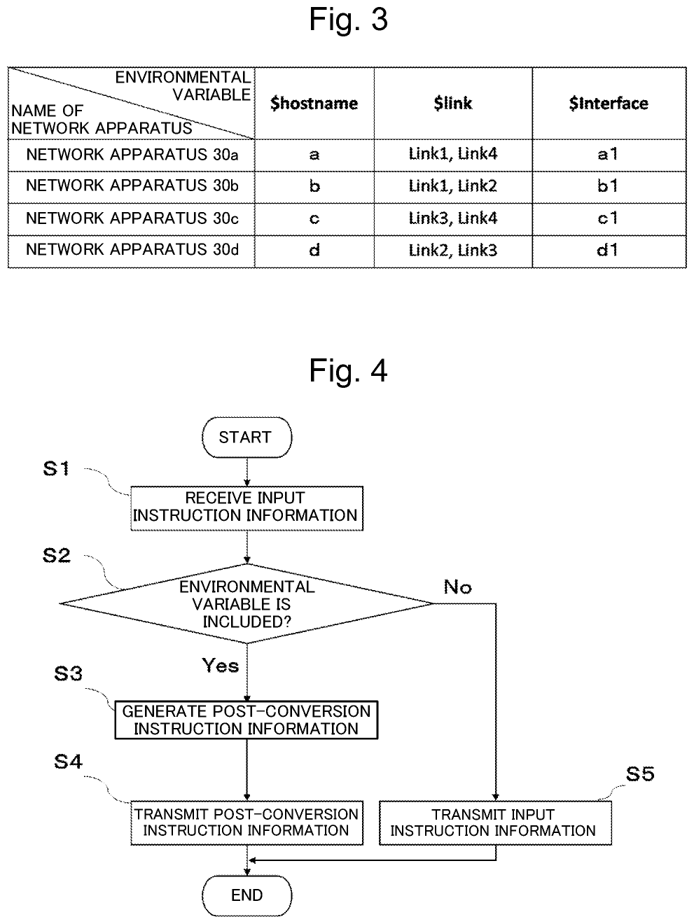

The environmental variable conversion information is information referred to, when the input instruction information includes an environmental variable, in order to convert the environmental variable into a value relevant to each of the network apparatuses 30a to 30d. FIG. 3 illustrates one example of the environmental variable conversion information. Each field of a “$interface” column stores a number given to an interface provided to each network apparatus. A number given to interface provided to the network apparatus 30a is a1, a number given to an interface provided to the network apparatus 30b is b1, a number given to an interface provided to the network apparatus 30c is c1, and a number given to an interface provided to the network apparatus 30d is d1.

The topology information is information for preparing the environmental variable conversion information. The topology information is, for example, node information such as a network apparatus name and a hostname of a network apparatus adjacent to each of the network apparatuses 30a to 30d, link information that is information on a link shared with an adjacent network apparatus, and interface information such as a port number used for connecting to an adjacent network apparatus.

When receiving input instruction information, the generation unit 24 determines whether the input instruction information includes an environmental variable.

Herein, it is assumed that the generation unit 24 determines that a part starting with “$” in the input instruction information is determined as an environmental variable. For example, when receiving input instruction information “$interface up”, the generation unit 24 determines that “$interface” which starts with “$” is an environmental variable.

When determining that input instruction information includes an environmental variable, the generation unit 24 generates, by referring to the environmental variable conversion information held by the storing unit 23, instruction information in which the environmental variable in the input instruction information is converted into a value relevant to each of the network apparatuses 30a to 30d, and transmits the generated instruction information to the relevant network apparatus.

For example, when receiving input instruction information “$interface up”, the generation unit 24 determines that “$interface” which starts with “$” is an environmental variable. The generation unit 24 generates instruction information in which “$interface” in the input instruction information is converted into each value corresponding to “$interface” of each of the network apparatuses 30a to 30d in the environmental variable conversion information illustrated in FIG. 3. Hereinafter, the instruction information converted with reference to the environmental variable conversion information is referred to post-conversion instruction information. For example, when giving an instruction to activate the interface a1 of the network apparatus 30a, the generation unit 24 refers to the environmental variable conversion information illustrated in FIG. 3 and converts “$interface” in the input instruction information into “a1”, and thereby generates post-conversion instruction information “a1 up” relevant to the network apparatus 30a. The generation unit 24 transmits the post-conversion instruction information “a1 up” to the network apparatus 30a.

The network apparatus 30a receives the post-conversion instruction information relevant to the own device from the control device 20, and executes an instruction content of the post-conversion instruction information. For example, when receiving the post-conversion instruction information “a1 up” having a content “activate the interface a1” as a post-conversion instruction information, the network apparatus 30a activates the interface a1 of the own device.

On the other hand, when determining that input instruction information does not include an environmental variable, the generation unit 24 transmits the input instruction information to each network apparatus.

In the above description, it is assumed that “a part starting with ‘$’ is determined as an environmental variable”, but it may be assumed that “a part starting with ‘#’ is determined as an environmental variable” or “a part starting with ‘!’ is determined as an environmental variable.”

### [Description of Operation]

FIG. 4 is a flowchart for describing an operation of command conversion processing of the generation unit 24 of the control system according to the first example embodiment.

When receiving input instruction information (S1), the generation unit 24 determines whether the input instruction information includes an environmental variable (S2).

When determining that the input instruction information includes an environmental variable (Yes in S2), the generation unit 24 refers to environmental variable conversion information, converts the environmental variable included in the input instruction information into a value relevant to each of the network apparatuses 30a to 30d, and thereby generates post-conversion instruction information relevant to each of the network apparatuses 30a to 30d (S3), and transmits the generated post-conversion instruction information relevant to each of the network apparatuses 30a to 30d (S4).

On the other hand, when determining that the input instruction information does not include an environmental variable (No is S2), the generation unit 24 transmits the input instruction information to each of the network apparatuses 30a to 30d (S5).

### Advantageous Effect

The control system according to the first example embodiment of the present invention is capable of automatically converting an environmental variable included in input instruction information into a value relevant to each network apparatus. Thereby, the control system according to the first example embodiment of the present invention is capable of reducing an amount of time and work required for converting an environmental variable into a value relevant to each network apparatus and giving an instruction to individual apparatuses.

The control system according to the first example embodiment of the present invention is capable of reducing a burden on a network administrator.

### [Overview]

An overview of the first example embodiment will be described.

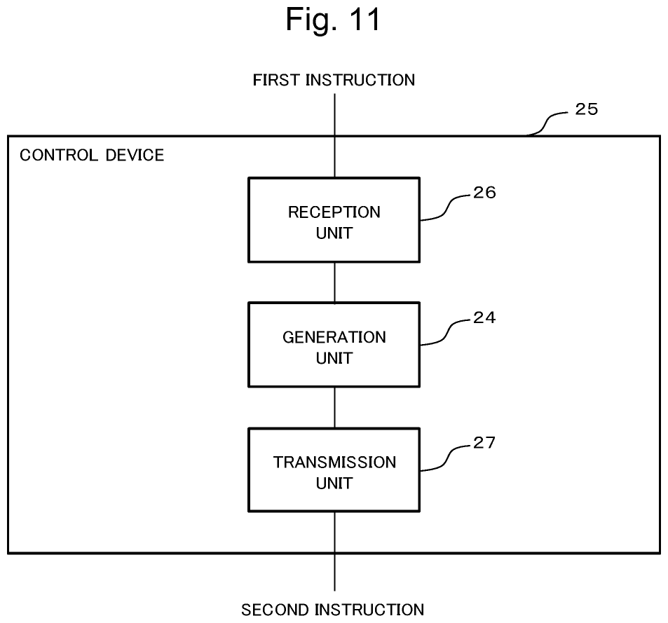

FIG. 11 is a diagram illustrating one example of an overview of a control device 25 according to the first example embodiment. The control device 25 includes a reception unit 26, the generation unit 24, and a transmission unit 27. The reception unit 26 receives first instruction information for the network apparatuses 30a to 30d. When the first instruction information satisfies a predetermined condition, the generation unit 24 generates, from the first instruction information, second instruction information relevant to each of the network apparatuses 30a to 30d. The transmission unit 27 transmits the generated second instruction information to each of the relevant network apparatuses 30a to 30d.

The control device 25 is capable of reducing a burden on a network administrator, based on the operation already described.

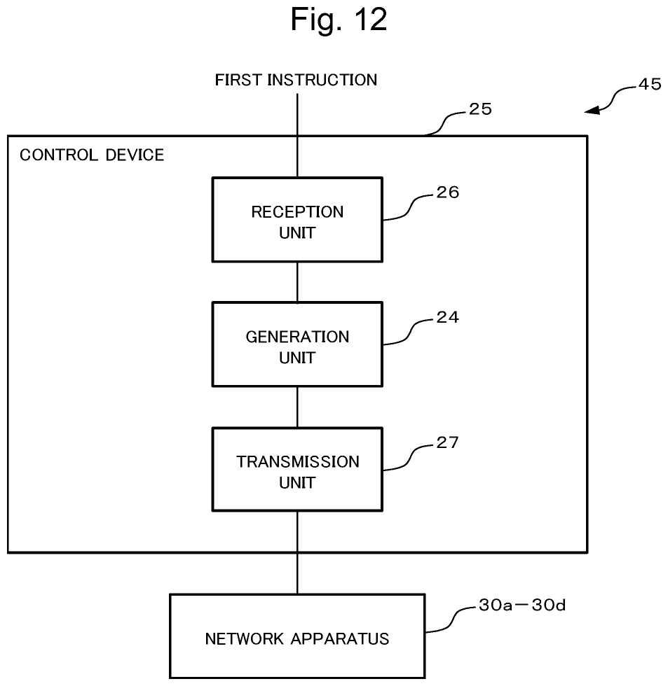

FIG. 12 is a diagram illustrating one example of a control system 45 being an overview of the control system according to the first example embodiment. The control system 45 includes the control device 25 and at least one of the network apparatuses 30a to 30d. The control device 25 includes the reception unit 26, the generation unit 24, and the transmission unit 27. The reception unit 26 receives first instruction information for the network apparatuses. When the first instruction information satisfies a predetermined condition, the generation unit 24 generates, from the first instruction information, second instruction information relevant to each of the network apparatuses 30a to 30d. The transmission unit 27 transmits the generated second instruction information to each of the relevant network apparatuses 30a to 30d. The network apparatuses 30a to 30d receive the second instruction information and execute a content of the second instruction information.

The control system 45 is capable of reducing a burden on a network administrator, based on the operation already described.

### [Hardware Configuration]

Next, hardware configurations of the control devices 20 and 25 are described with reference to the control device 20.

Each component of the control device 20 may be configured by a hardware circuit. Alternatively, in the control device 20, each component may be configured by using a plurality of devices connected via a network. Further alternatively, in the control device 20, a plurality of components may be configured by one piece of hardware.

Alternatively, the control device 20 may be achieved as a computer device including a central processing unit (CPU), a read only memory (ROM), and a random access memory (RAM). The control device 20 may be achieved as a computer device further including an input and output circuit (IOC) in addition to the above-described configuration. The control device 20 may be achieved as a computer device further including a network interface circuit (NIC) in addition to the above-described configuration.

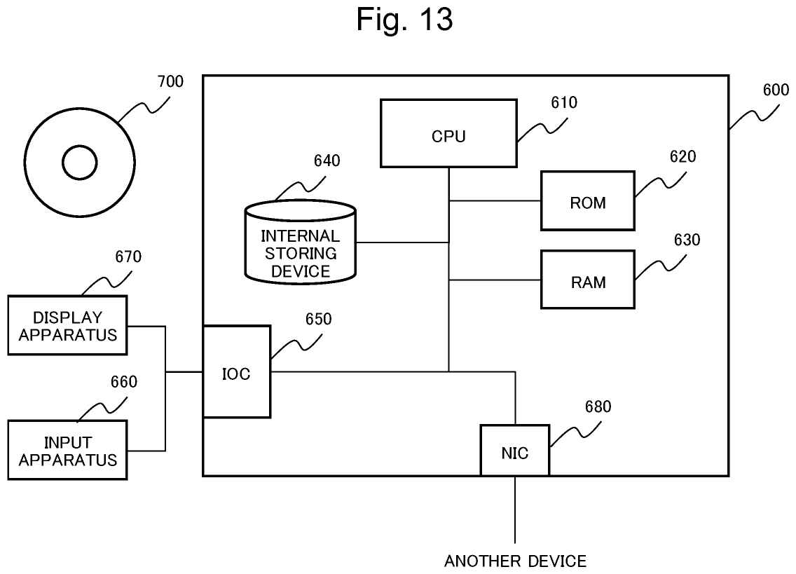

FIG. 13 is a block diagram illustrating an information processing device 600 being one example of a hardware configuration of the control device 20. The information processing device 600 includes a CPU 610, a ROM 620, a RAM 630, an internal storing device 640, an IOC 650, and a NIC 680, and configures a computer device.

The CPU 610 reads a program from the ROM 620 and/or the internal storing device 640. Then, the CPU 610 controls, based on the read program, the RAM 630, the internal storing device 640, the IOC 650, and the NIC 680. A computer including the CPU 610 controls the configuration, and achieves each function as the communication interface unit 21, the preparation unit 22, and the generation unit 24 illustrated in FIG. 2. Alternatively, the computer including the CPU 610 controls the configuration, and achieves each function as the reception unit 26, generation unit 24, and the transmission unit 27 illustrated in FIG. 11. When achieving each function, the CPU 610 may use the RAM 630 or the internal storing device 640 as a temporary storage medium for the program.

Further, the CPU 610 may read, by using an unillustrated recording medium reading device, a program included in a recording medium 700 storing the program in such a way as to be computer readable. Alternatively, the CPU 610 may receive, via the NIC 680, a program from an unillustrated external device, store the program in the RAM 630 or the internal storing device 640, and operate on the basis of the stored program.

The ROM 620 stores a program to be executed by the CPU 610 and fixed data. The ROM 620 is, for example, a programmable-ROM (P-ROM) or a flash ROM. The RAM 630 temporarily stores a program to be executed by the CPU 610 and data. The RAM 630 is, for example, a dynamic-RAM (D-RAM). The internal storing device 640 stores data that are stored by the information processing device 600 for a long term and a program. The internal storing device 640 operates as the storing unit 23. Further, the internal storing device 640 may operate as a temporary storing medium of the CPU 610. The internal storing device 640 is, for example, a hard disk drive, a magneto-optical disk drive, a solid state drive (SSD), or a disk array device.

The ROM 620 and the internal storing device 640 are non-transitory recording media. On the other hand, the RAM 630 is a transitory recording medium. And, the CPU 610 can operate on the basis of a program stored in the ROM 620, the internal storing device 640, or the RAM 630. In other words, the CPU 610 can operate by using a non-transitory recording medium or a transitory recording medium.

The IOC 650 mediates data between the CPU 610, and an input apparatus 660 and a display apparatus 670. The IOC 650 is, for example, an I/O interface card or a universal serial bus (USB) card. Further, the IOC 650 is not limited to a wired form such as a USB, and a wireless form may be used as the IOC 650.

The input apparatus 660 is an apparatus that receives an input instruction from an operator of the information processing device 600. The input apparatus 660 is, for example, a keyboard, a mouse, or a touch panel. The display apparatus 670 is an apparatus that displays information for an operator of the information processing device. The display apparatus 670 is, for example, a liquid crystal display, an organic electro-luminescence display, or an electronic paper.

The NIC 680 relays data exchange with an unillustrated external device via a network. The NIC 680 operates as the communication interface unit 21, the reception unit 26, and the transmission unit 27. The NIC 680 is, for example, a local area network (LAN) card. Further, the NIC 680 is not limited to a wired form, and a wireless form may be used as the NIC 680.

The information processing device 600 configured as above-description is capable of achieving an advantageous effect similar to the control device 20. A reason for this is that the CPU 610 of the information processing device 600 is capable of achieving a function similar to the control device 20, based on a program.

### (Second Example Embodiment) [Description of Configuration]

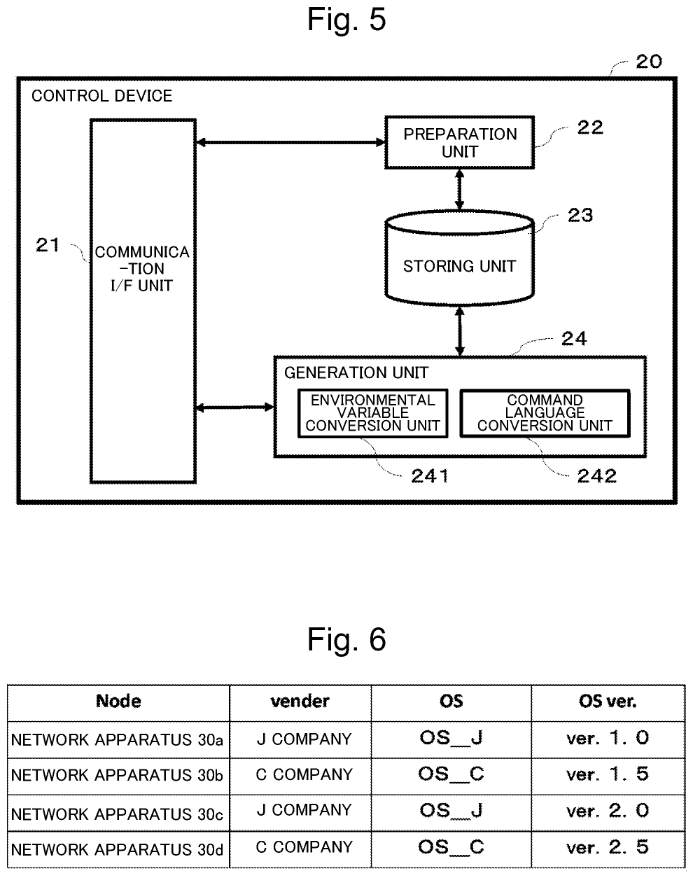

FIG. 5 is a diagram illustrating a configuration of a control device 20 of a control system according to a second example embodiment. Hereinafter, a configuration similar to the first example embodiment is appended with the same reference sign as in FIG. 2, and detailed description thereof is omitted.

A preparation unit 22 acquires, from network apparatuses, apparatus information of the network apparatuses, and stores the apparatus information in a storing unit 23.

The apparatus information is information for determining a command language relevant to each network apparatus. FIG. 6 illustrates one example of the apparatus information. The apparatus information is, for example, a vender name, an operating system (OS) name, an OS version (ver.), and the like of each network apparatus.

The storing unit 23 preliminarily holds command language conversion information for converting a command language of a setting instruction into a command language relevant to each network apparatus.

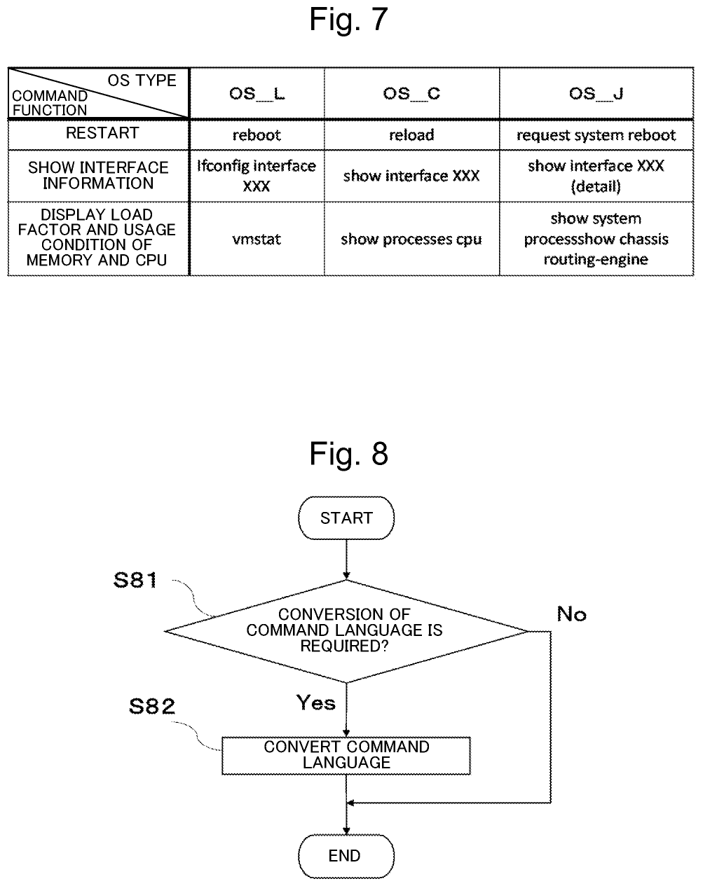

The command language conversion information is information referred to for converting a command language of input instruction information. FIG. 7 illustrates one example of the command language conversion information. For example, when “reboot” is received as the input instruction information, conversion into “reload” that has a same command function is performed for a network apparatus relevant to an OS_C, and conversion into “request system reboot” is performed for a network apparatus relevant to an OS_J.

A generation unit 24 includes an environmental variable conversion unit 241 and a command language conversion unit 242.

The command language conversion unit 242 determines, based on the apparatus information, whether a command language of a setting instruction is a command language relevant to each of network apparatuses 30a to 30d.

For example, the command language conversion unit 242 determines, based on the apparatus information illustrated in FIG. 6, whether a command language of the received setting instruction is a command language relevant to each of the network apparatuses 30a to 30d. For example, when the command language of the setting instruction is a command language relevant to an OS_L, the command language conversion unit 242 determines that conversion into a command language relevant to the OS_J is required to be performed for the network apparatus 30a.

When determining that conversion of a command language of the setting instruction is required, the command language conversion unit 242 refers to the command language conversion information, and thereby generates a setting instruction in which a command language of input instruction information is converted into a command language relevant to each of the network apparatuses 30a to 30d.

For example, when “reboot” is input as a setting instruction in order to instruct “restart” to the network apparatuses 30a to 30d, the command language conversion unit 242 refers to the command language conversion information illustrated in FIG. 7, and generates, for the network apparatus 30a whose OS is the OS_J, a setting instruction “request system reboot” by converting a command language of “reboot”.

The generation unit 24 transmits the generated setting instruction to each of the relevant network apparatuses, via a communication interface unit 21. For example, to the network apparatus 30a, the generation unit 24 transmits “request system reboot”.

### [Description of Operation]

FIG. 8 is a flowchart for describing an operation of command conversion processing performed by the command language conversion unit 242 among operations of the control system according to the second example embodiment. The command language conversion unit 242 determines, based on apparatus information, whether conversion of a command language of a setting instruction is required (S81).

When determining that conversion of the command language of the setting instruction is required (Yes in S81), the command language conversion unit 242 refers to command language conversion information, and thereby converts the command language of the setting instruction into a command language relevant to each network apparatus.

When determining that conversion of the command language of the setting instruction is not required (No in S81), the command language conversion unit 242 does not convert the command language of the setting instruction.

Types of a setting instruction that can be generated by processing of environmental variable conversion of the environmental variable conversion unit 241 and processing of command language conversion of the command language conversion unit 242 are the following four types (1) to (4), that are, (1) a setting instruction in which an environmental variable and a command language are converted, (2) a setting instruction in which an environmental variable is converted while a command language is not converted, (3) a setting instruction in which an environmental variable is not converted while a command language is converted, and (4) neither a setting instruction in which an environmental variable nor a command language is converted.

Note that, the control device 20 may update the environmental variable conversion information with a topological change in a network to which the network apparatuses 30a to 30d belong.

### Advantageous Effect

The control system according to the second example embodiment of the present invention is capable of automatically converting a command language of a setting instruction into a command language relevant to each network apparatus. Thereby, when a network administrator inputs a setting instruction, an amount of time and work required for individually inputting a command in a command language relevant to each network apparatus can be reduced.

### (Third Example Embodiment) [Description of Configuration]

A difference between a control system according to a third example embodiment and the control system according to the first and second example embodiments is that a management device 10 includes a GUI unit 100.

A network administrator can input and transmit input instruction information to network apparatuses 30a to 30d by operating the GUI unit 100.

In the following, a configuration of the GUI unit 100 will be described.

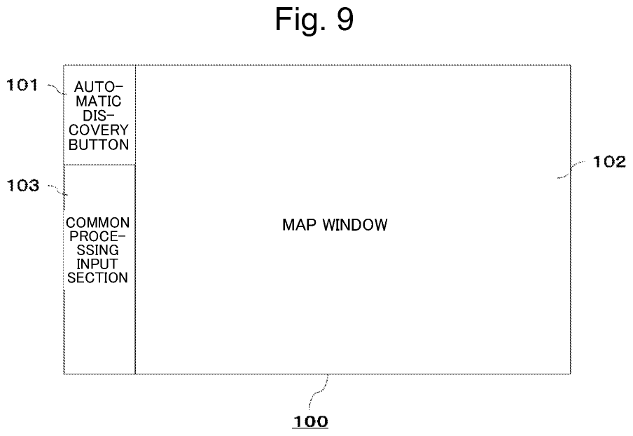

FIG. 9 is a diagram illustrating the configuration of the GUI unit 100. The GUI unit 100 is an operation screen including an automatic discovery button 101, a map window 102, and a common processing input section 103.

A network administrator operates the GUI unit 100 by operating a pointing device such as a mouse.

The automatic discovery button 101 is a button for acquiring topology information of a network.

When a user operates a pointing device on a GUI screen and pushes the automatic discovery button 101, the GUI unit 100 displays a topology diagram on the map window 102, based on topology information acquired from each of the network apparatuses 30a to 30d managed by a control device 20.

When giving a common instruction to the network apparatuses 30a to 30d, a user inputs a setting instruction of a common processing content to the common processing input section 103. The setting instruction input to the common processing input section 103 is transmitted to all the network apparatuses 30a to 30d.

### [Description of Operation]

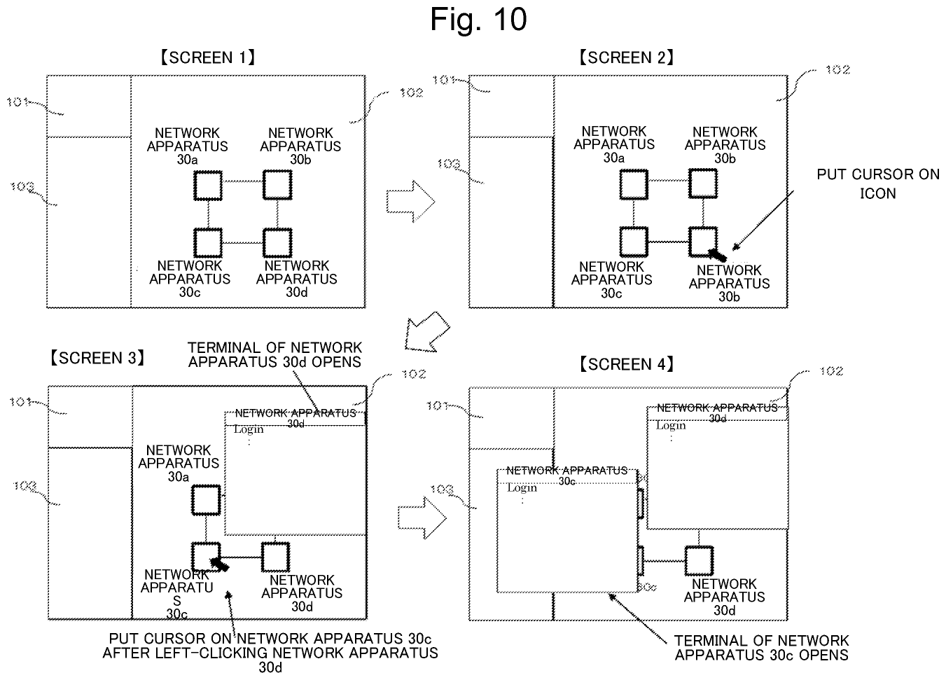

FIG. 10 illustrates an operational example of the GUI unit 100. When a network administrator operates a pointing device on the GUI screen and pushes the automatic discovery button 101 of the GUI unit 100, preparation unit 22 acquires topology information from each of the network apparatuses 30a to 30d. The GUI unit 100 displays, based on the acquired topology information, a topology diagram of a network on the map window 102. An icon of each network apparatus is displayed on the map window 102 (screen 1 in FIG. 10).

By putting a cursor on an icon of a network apparatus displayed on the map window 102, a terminal of the network apparatus on which the cursor is put can be opened. For example, when a cursor is put on the icon of the network apparatus 30d (screen 2 in FIG. 10), a terminal of the network apparatus 30d can be opened (screen 3 in FIG. 10).

Further, by clicking an icon, a terminal of a network apparatus can be kept open for a predetermined time. For example, when the icon of the network apparatus 30d is clicked, the terminal of the network apparatus 30d can be kept open for a predetermined time (screen 3 in FIG. 10).

Further, a terminal of another network apparatus can be opened while a terminal of a network apparatus is kept open. For example, when the cursor is put on the icon of the network apparatus 30c while the terminal of the network apparatus 30d is opened, the terminal of the network apparatus 30d and the terminal of the network apparatus 30c can be opened at the same time (screen 4 in FIG. 10).

### Advantageous Effect

A human error such as a mis-input of a command can be avoided since a command can be input by operating the GUI unit 100 to a terminal of a network apparatus while being checked against a topology diagram. Further, efficiency in inputting a setting instruction for a plurality of network apparatuses is improved as a result of including the common processing input section 103.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2017-236555, filed on Dec. 11, 2017, the disclosure of which is incorporated herein in its entirety by reference.

### REFERENCE SIGNS LIST

10 Management device
20 Control device
21 Communication interface unit
22 Preparation unit
23 Storing unit
24 Generation unit
25 Control device
25 Reception unit
26 Transmission unit
30a-30d Network apparatus
45 Control system
100 GUI unit
101 Automatic discovery button
102 Map window
103 Common processing input section
241 Environmental variable conversion unit
242 Command language conversion unit
600 Information processing device
610 CPU
620 ROM
630 RAM
640 Internal storing device
650 IOC
660 Input apparatus
670 Display apparatus
680 NIC
700 Recording medium

1. A control method comprising,
by a control device controlling network apparatuses:
receiving first instruction information for the network apparatuses;
generating, when the first instruction information satisfies a predetermined condition, second instruction information relevant to each of the network apparatuses, from the first instruction information; and
transmitting the generated second instruction information to each of the relevant network apparatuses.

2. The control method according to claim 1, further comprising,
by the control device:
receiving the first instruction information as a first command;
generating, when the first command includes an environmental variable, a second command relevant to each of the network apparatuses by converting the environmental variable into a value relevant to each of the network apparatuses; and
transmitting the generated second command to each of the relevant network apparatuses.

3. The control method according to claim 2, further comprising,
by the control device:
acquiring, from the network apparatuses, topology information of networks to which the network apparatuses belong;
preparing, based on the topology information, environmental variable conversion information for converting the environmental variable of the first command into a value relevant to each of the network apparatuses; and
generating, according to the environmental variable conversion information, the second command relevant to each of the network apparatuses.

4. The control method according to claim 3, further comprising,
by the control device:
acquiring, from each of the network apparatuses, apparatus information of the network apparatuses; and
converting a command language of the first command or the second command into a command language relevant to each of the network apparatuses, based on the apparatus information and command language conversion information for converting a command language of the first command or the second command.

5. The control method according to claim 4, further comprising,
by the control device:
updating the environmental variable conversion information with a topological change in the networks to which the network apparatuses belong.

6. The control method according to claim 4, further comprising,
by the control device:
holding the environmental variable conversion information and the command language conversion information.

7. A control device comprising:
a reception unit configured to receive first instruction information for network apparatuses;
a generation unit configured to generate, when the first instruction information satisfies a predetermined condition, second instruction information relevant to each of the network apparatuses, from the first instruction information; and
a transmission unit configured to transmit the generated second instruction information to each of the relevant network apparatuses.

8. A control system comprising:
a control device according to claim 7; and
the network apparatuses receiving the second instruction information, and executing an instruction content of the second instruction information.

9. A non-transitory recording medium recording a program causing a control device controlling network apparatuses to execute:
processing of receiving first instruction information for the network apparatuses;
processing of generating, when the first instruction information satisfies a predetermined condition, second instruction information relevant to each of the network apparatuses, from the first instruction information; and
processing of transmitting the generated second instruction information to each of the relevant network apparatuses.

10. The control method according to claim 5, further comprising,
by the control device:
holding the environmental variable conversion information and the command language conversion information.

11. A control system comprising:
a control device according to claim 2; and
the network apparatuses receiving the second instruction information, and executing an instruction content of the second instruction information.
